(19) United States
(12) Patent Application Publication
(10) Pub. No.: US 2009/0132538 A1
(43) Pub. Date: May 21, 2009

(54) INFORMATION PROCESSING APPARATUS, INFORMATION PROCESSING SYSTEM, AND INFORMATION PROCESSING METHOD

(76) Inventors: Go Kojima, Yamato (JP); Ryoichi Ueda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/274,624

(22) Filed: Nov. 20, 2008

(30) Foreign Application Priority Data
Nov. 20, 2007 (JP) 2007-300691

(51) Int. Cl. G06F 17/30

(52) U.S. Cl. 707/9; 707/E17.032

(57) ABSTRACT

To keep data security in an information processing system, an information processing apparatus communicably coupled with a user terminal communicably coupled with a secret data management device managing secret data that a user intends to keep secret, includes a publicly-available data storage unit that stores publicly-available data that the user does not intend to keep secret; a publicly-available data acquiring unit that reads the publicly-available data from the publicly-available data storage unit; a program storage unit that stores a program to be executed by the user terminal; and a program sending unit that sends the program to the user terminal with the read publicly-available data attached thereto. The above-mentioned program contains instructions to cause the user terminal to execute the steps of: acquiring the secret data by accessing the secret data management device; and outputting the acquired secret data and publicly-available data attached to the program.

### CROSS-REFERENCE TO RELATED APPLICATIONS

The present application claims a priority from Japanese Patent Application No. 2007-300691 filed on Nov. 20, 2008, the content of which herein incorporated by reference.

### BACKGROUND OF THE INVENTION

1. Field of the Invention

The present invention relates to an information processing apparatus, an information processing system, and an information processing method.

2. Related Art

Many of corporate business systems which have been implemented as desktop applications executed on client apparatuses, are now starting to be provided as services on the Web. Web-based services are often operated by external service providers. In this case, the Web server side also manages information such as personal information and confidential information that are desired to be kept secret within the business enterprises. Therefore, the data may be leaked out from the providers outside of the business enterprise because the providers can access the data managed by the Web server.

Techniques have been proposed to cope with such problem so as to keep the data security. For example, Japanese Patent Application Laid-open Publication No. 2003-304234 has described a technique for keeping the data security by storing, in a tamper-resistant storage, a secret key used for encryption of information to be provided to a Web service providing device or an authentication authority. In a technique described in Japanese Patent Application Laid-open Publication No. 2006-39674, a sending key is calculated from a secret key and purchase desire information which has been sent by the user and in which a keyword and an element selected by an user are kept secret, and the user side is allowed to decode only information corresponding to the selected keyword on the basis of the sending key, the selected element and the like.

However, in the conventional techniques, a special device or program for keeping the information security has to be installed in an apparatus on the user side or an information provider side. In addition, the conventional techniques have not been used in general-purpose application because the information targeted for keeping its security is sometimes information to be transmitted in authenticating processing, or information to be acquired by an external service provider, and also because the conventional techniques are only developed to keep the security for limited situations and information.

### SUMMARY OF THE INVENTION

The present invention is made in consideration of such a background. An object of the present invention is to provide an information processing apparatus, an information processing system, and an information processing method for enabling data security to be kept.

According to a principal aspect of the present invention for solving the above-mentioned problems, an information processing apparatus is communicably coupled with a user terminal communicably coupled with a secret data management device managing secret data that is the data a user intends to keep secret. The information processing apparatus includes: a publicly-available data storage unit that stores data the user does not intend to keep secret; an publicly-available data acquiring unit that reads the publicly-available data from the publicly-available data storage unit; a program storage unit that stores a program for the user terminal to execute; and a program sending unit that sends the program with the read publicly-available data attached to the program, to the user terminal. The program contains instructions to cause the user terminal to execute the steps of: acquiring the secret data by accessing the secret data management device; and outputting the acquired secret data and the publicly-available data attached to the program.

According to the present invention, an information processing apparatus, an information processing system, and a method for controlling information processing therein which enables data security, can be provided.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing an entire configuration of an information processing system according to an embodiment;

FIG. 2 is a diagram showing a hardware configuration of a typical computer used in this embodiment;

FIG. 3 is a diagram showing a software configuration of the information processing system according to this embodiment;

FIG. 4 is a diagram showing an example of a table 4-20 managed by a secret data storage unit 205;

FIG. 5 is a diagram showing an example of a script 21 for reply;

FIG. 6 is a diagram showing an example of a table 4-10 managed by a publicly-available data storage unit 305;

FIG. 7 is a diagram showing an example of a configuration of data allocated position information stored in a data allocated position information storage unit 306;

FIG. 8 is a diagram showing an example of a page generation script 31;

FIG. 9 is a diagram showing an example of a data access script 32;

FIG. 10 is a diagram showing an example of a data access script 33 for browsers;

FIG. 11 is a diagram showing a flow of a processing for a reference request when no secret data exits;

FIG. 12 is a diagram showing a flow of a data update processing when no secret data exists;

FIG. 13 is a diagram showing a flow of a processing for the reference request when the secret data exists;

FIG. 14 is a diagram showing a flow of a data acquisition processing defined in the data access script 32;

FIG. 15 is a diagram showing a flow of a data acquisition processing defined in the data access script 33 for browsers;

FIG. 16 is a diagram showing an example of the data allocated position information stored in the data allocated position information storage unit 306;

FIG. 17 is a diagram showing an example of a configuration of a schedules table managed by the publicly-available data storage unit 305;

FIG. 18 is a diagram showing an example of the schedules table 4-30 managed by the secret data storage unit 205;

FIG. 19 is a diagram showing an example of the access script 33-1 for browsers; and

FIG. 20 is a diagram showing a flow of the data acquisition processing defined in the data access script 33-1 for browsers.

### DETAILED DESCRIPTION OF THE INVENTION

Hereinafter, with reference to the drawings, an information processing system according to an embodiment of the present invention will be described.

### 1. System Configuration

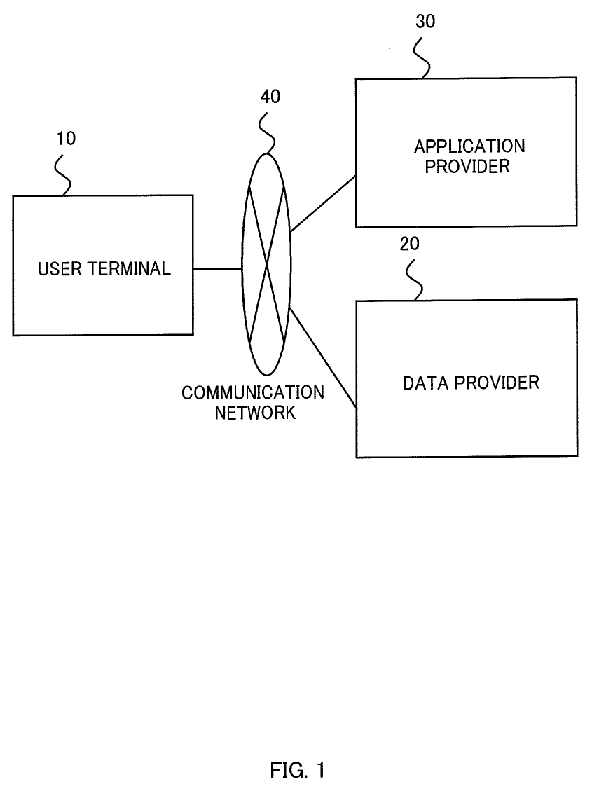

FIG. 1 is a diagram showing an entire configuration of the information processing system according to the present embodiment. As shown in the drawing, the information processing system according to the present embodiment is configured to include a user terminal 10, a data provider 20, and an application provider 30. The user terminal 10, the data provider 20, and the application provider 30 are communicably coupled to each other through a communication network 40. The communication network 40 is, for example, the Internet or a Local Area Network (LAN) and is built with Ethernet (registered trademark), a telephone network, a wireless network, and the like. In the present embodiment, communication by use of TCP/IP is performed on the communication network 40.

The information processing system according to the present embodiment provides a service such as schedule management or the like as a Web application, by using two servers, namely the data provider 20 and the application provider 30. The application provider 30 is the so-called application server, and performs information processing needed for provision of services. Usually, Web applications are provided by a single server. However, in the present embodiment, among data needed for the Web applications, data desired to keep secret within a business enterprise (organization) to which an user belongs, such as personal information and confidential information, (hereinafter, referred to as secret data) is managed by the data provider 20, and only the other data (hereinafter, referred to as publicly-available data) is managed by the application provider 30. This reduces a risk that the secret data may be leaked out to the service provider even when the application provider 30 (for example, service provider or the like) is operated by an organization different from the business enterprise to which the user belongs.

The user terminal 10 is a computer operated by the user of the information processing system. The user terminal 10 includes, for example, personal computers, workstations, a Personal Data Assistant (PDA), and mobile telephone terminals. A web browser is in execution in the user terminal 10. The user accesses the data provider 20 and the application provider 30 by operating the web browser. Incidentally, while the user terminals 10 may exist as much as the number of the users, only one user terminal 10 is included in the present embodiment for a simple description.

The data provider 20 (corresponding to a secret data management device of the present invention) is a computer includes, for example, the personal computers, the workstations, or the like, which manages the secret data. It is assumed that, the data provider 20 is, for example, installed within the same organization as where the user terminal 10 is installed, and is operated and managed by the same organization as the user terminal 10 is operated and managed by.

The application provider 30 is a computer including, for example, the personal computers, the workstations, or the like, which executes Web applications for providing information processing service. It is assumed that the application provider 30 is, for example, managed by the service provider different from the organization in which the user terminal 10 and the data provider 20 are installed.

### 2. Hardware Configuration

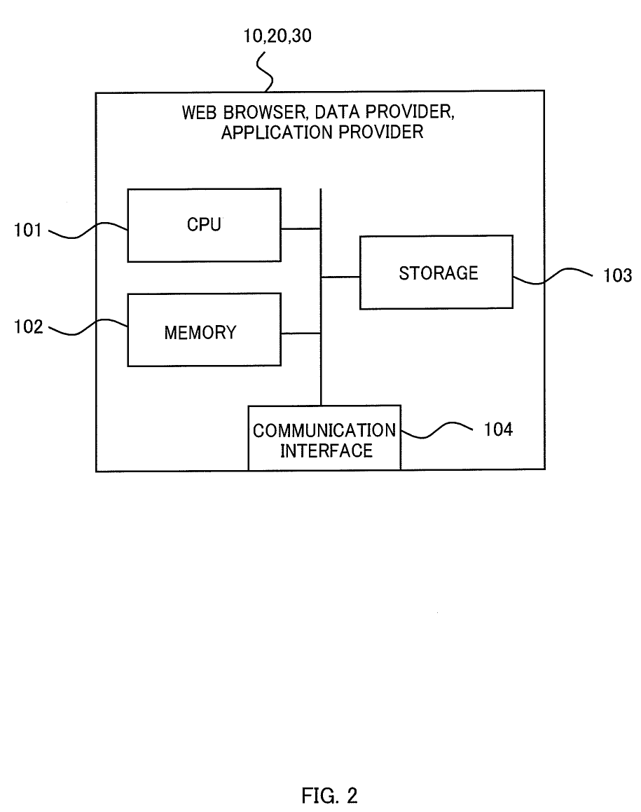

FIG. 2 is a diagram showing a hardware configuration of a typical computer used for the user terminal 10, the data provider 20, and the application provider 30 according to the present embodiment. As shown in the drawing, the computer used therein includes a CPU 101, a memory 102, a storage 103, and a communication interface 104. The storage 103 includes, for examples, a hard disk drive, a flash memory, and a CD-ROM drive that store various kinds of data and programs. The CPU 101 provides various kinds of functions by reading the program stored in the storage 103 onto the memory 102 and then executing the program. The communication interface 104 is an interface for coupling with the communication network 40. The communication interface 104 includes, for example, an adapter for coupling with Ethernet®, a modem for coupling with a public switched telephone network, and a wireless communication device for performing wireless communication.

### 3. Software Configuration

### 3.1. Software Configuration of User Terminal 10

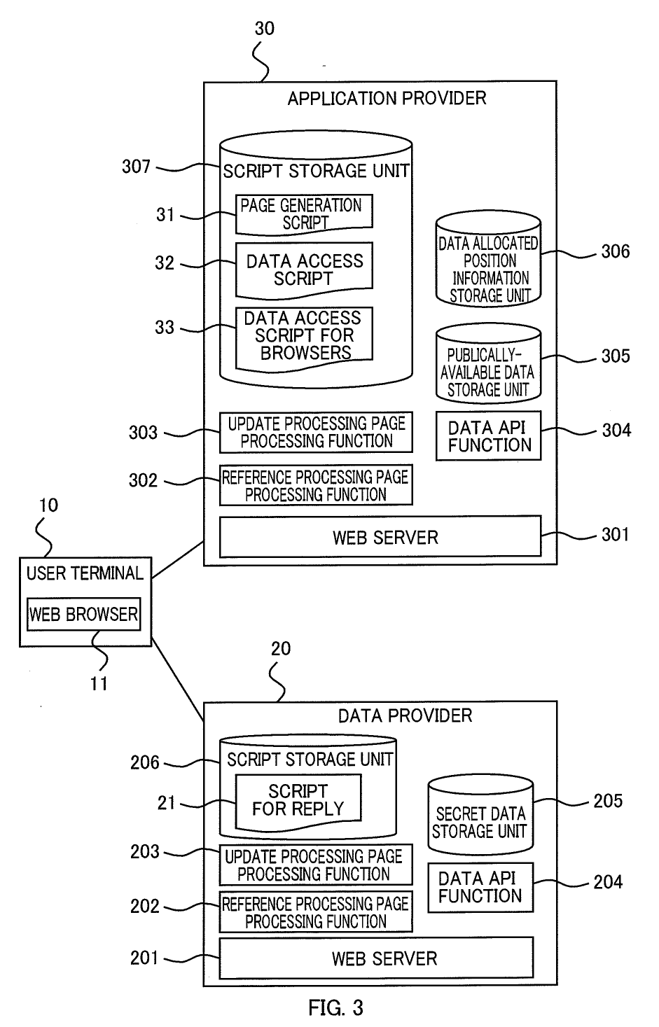

FIG. 3 is a diagram showing a software configuration of the information processing system according to the present embodiment.

The user terminal 10 includes a web browser 11. In response to the user's operation, the web browser 11 sends a request in accordance with Hyper Text Transfer Protocol (HTTP) to the data provider 20 or the application provider 30, thereby, accessing publicly-available data and secret data. It is assumed that the web browser 11 operated on the user terminal 10 is a general browser.

Moreover, in response to the user's operation, the web browser 11 sends an HTTP request including a reference request for referring to the secret data (hereinafter, simply referred to as a reference request) to the data provider 20, displays, on the screen, the secret data sent by the data provider 20 in response to the reference request, and then sends an HTTP request including an update request for performing registration, update, and deletion of the secret data (hereinafter, these are generally referred to as update) to the data provider 20. Thereby, the secret data managed by the data provider 20 is updated. The web browser 11 sends an HTTP request including the reference request for referring to the publicly-available data to the application provider 30, displays, on the screen, the publicly-available data returned from the application provider 30 in response to the reference request, and then sends the HTTP request including the update request for updating the publicly-available data to the application provider 30. Thereby, the publicly-available data managed by the application provider 30 is updated. Specifications of these reference requests and registration requests are defined as a predetermined Application Program Interface (API).

Incidentally, the web browser 11 is implemented when the CPU 101 included in the user terminal 10 reads the program stored in the storage 103 onto the memory 102 and executes the program.

### 3.2. Software Configuration of Data Provider 20

The data provider 20 includes a Web server 201, a reference processing page processing function 202, an update processing page processing function 203, a data API function 204, a secret data storage unit 205, and a script storage unit 206. The Web server 201, the reference processing page processing function 202, the update processing page processing function 203, and the data API function 204 are implemented, when the CPU 101 included in the data provider 20 reads the program stored in the storage 103 to the memory 102 and executes the program.

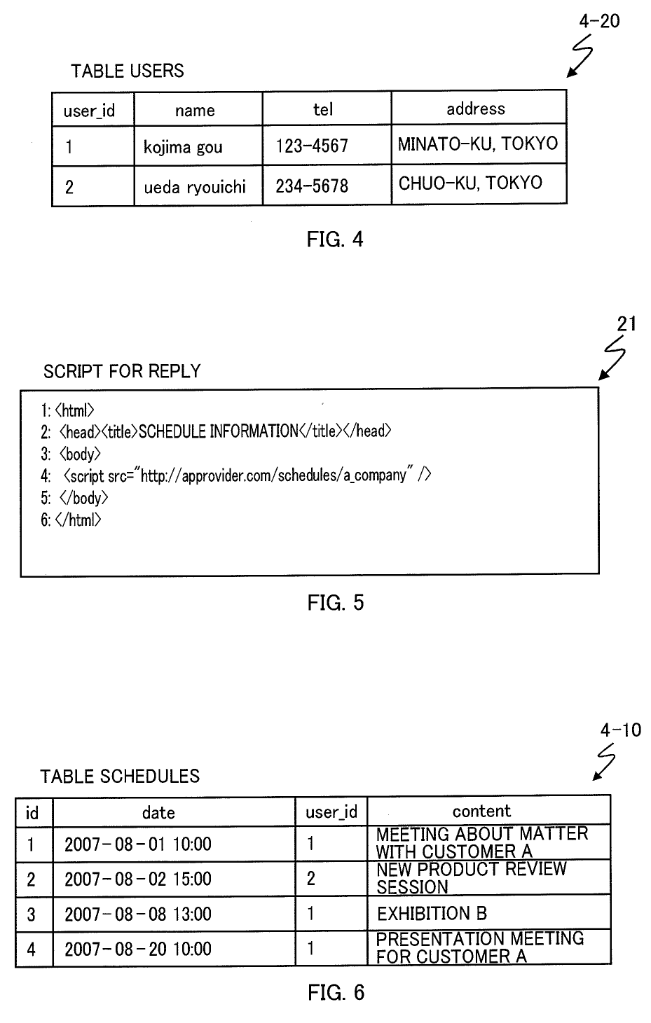

The secret data storage unit 205 stores the secret data. The secret data storage unit 205 is implemented, for example, as a Relational Database Management System (RDBMS) that manages the secret data in units of table. In this case, the secret data storage unit 205 is formed of a function implemented when the CPU 101 included in the data provider 20 reads the program stored in the storage 103 to the memory 102 and executes the program, and formed of a storage region provided by the memory 102 and/or the storage 103. Alternatively, the secret data storage unit 205 may be implemented as the storage region provided by the memory 102 and/or the storage 103. FIG. 4 shows an example of a table 4-20 managed by the secret data storage unit 205. A table name that indicates the table 4-20 is “users.” The table 4-20 includes columns of “user_id,” “name,” “tel,” and “address.”

The script storage unit 206 stores a script that the web server 201 returns in response to a first access from the user terminal 10 (hereinafter, referred to as a script 21 for reply). The script storage unit 206 is implemented as a storage region provided by the memory 102 and/or storage 103 that are included in the data provider 20.

FIG. 5 shows an example of the script 21 for reply. As shown in the drawing, a command for accessing the application provider 30 is described in the script 21 for reply (in the fourth line). The web browser 11 of the user terminal 10 accesses the application provider 30 in response to the command included in the script 21 for reply.

In response to the HTTP request sent from the user terminal 10, the web server 201 returns a web page described in HyperText Markup Language (HTML) to the user terminal 10, or executes various kinds of programs, so as to return the result to the user terminal 10 as the Web page. The Web page can include a program (hereinafter, referred to as a script) described with JavaScript. The script included in the Web page is executed by the web browser 11 of the user terminal 10.

At the time of the first time access from the user terminal 10, the reference processing page processing function 202 returns the script 21 for reply stored in the script storage unit 206. At the time of subsequent access, if the reference request is included in the HTTP request received by the Web server 201, the reference processing page function 202 is activated. Then, the reference processing page function 202 calls the data API function 204 so as to access the secret data storage unit 205 and acquire the secret data. Thereafter, the reference processing page function 202 generates a Web page including the acquired secret data, and returns the Web page to the user terminal 10.

When an update request is included in the HTTP request received by the Web server 201, the update processing page processing function 203 calls the data API function 204, accesses the secret data storage unit 205, and updates the secret data. Then, the update processing page processing function 203 generates the Web page showing the result, and returns the Web page to the user terminal 10.

The data API function 204 provides a function to access the secret data storage unit 205 in response to a call from the reference processing page processing function 202 or the update processing page processing function 203. The data API function 204 is called, for example, by use of a table name and a condition as arguments so as to generate a query to the RDBMS where the table name and conditions are described. Thereafter, the data API function 204 reads out the data that satisfies the condition from the table managed by the RDBMS, and then performs update.

### 3.3. Software Configuration of Application Provider 30

The application provider 30 includes a Web server 301, a reference processing page processing function 302, an update processing page processing function 303, a data API function 304, an publicly-available data storage unit 305, a data allocated position information storage unit 306, and a script storage unit 307. The Web server 301, the reference processing page processing function 302, the update processing page processing function 303, and the data API function 304 are implemented, when the CPU 101 included in the application provider 30 reads the program stored in the storage 103 to the memory 102 and executes the program.

The publicly-available data storage unit 305 stores publicly-available data. The publicly-available data storage unit 305 is implemented, for example, as the RDBMS that manages the publicly-available data in units of table. In this case, the publicly-available data storage unit 305 is formed of a function implemented when the CPU 101 included in the application provider 30 reads the program stored in the storage 103 to the memory 102 and executes the program, and formed of a storage region provided by the memory 102 and/or the storage 103. Alternatively, the publicly-available data storage unit 305 may be implemented as the storage region provided by the memory 102 and/or the storage 103. FIG. 6 shows an example of a table 4-10 managed by the publicly-available data storage unit 305. The table name that indicates the table 4-10 is “schedules.” The table 4-10 includes columns of “id,” “date,” “user_id,” and “content.”

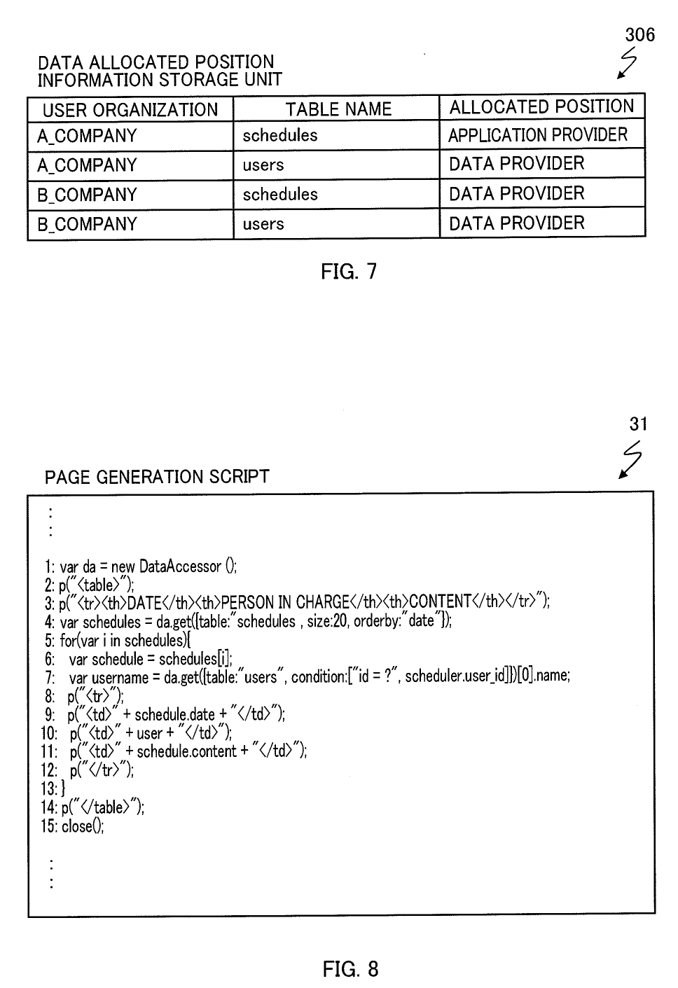

The data allocated position information storage unit 306 stores the information that indicates a position where the data is stored (hereinafter, referred to as data allocated position information). FIG. 7 shows an example of a configuration of the data allocated position information stored in the data allocated position information storage unit 306. As shown in the drawing, the data allocated position information includes a user organization, a table name, and an allocated position. The user organization is the information that identifies the organization in which the user terminal 10 and the data provider 20 are installed. The table name is the name that indicates the table in which the data used for the Web application is stored. The allocated position is the information that indicates where the table indicated by the table name is managed. In the present embodiment, the allocated position is either a “data provider” indicating the data provider 20 or an “application provider” indicating the application provider 30. While the data allocated position information storage unit 306 stores the data allocated position information for every organization, the user terminal 10 and the data provider 20 are installed in the organization “A_COMPANY” in the present embodiment for simple description.

The data API function 304 accesses the publicly-available data storage unit 305. The data API function 304 accesses the RDBMS that implements the publicly-available data storage unit 305, and performs a reference processing and update processing of data. The data API function 304 is formed, for example, of a driver program for accessing the RDBMS, and of a program that calls the driver program according to a request for a processing from an outside.

The script storage unit 307 (corresponding to a program storage unit of the present invention) stores various kinds of scripts, such as a page generation script 31, a data access script 32, and a data access script 33 for browsers.

In the present embodiment, only one page generation script 31 is stored in the script storage unit 307 for the sake of simple description. Alternatively, for example, the page generation script 31 may be prepared for every function needed for schedule management service, and the page generation script 31 needed for a processing of the schedule management service may be executed. Such a processing to select and execute a needed script is implemented in an application program that implements a general web application, and therefore, the description of the processing will be omitted in the present embodiment.

The page generation script 31 (corresponding to an access information of the present invention) is the script for performing an information processing concerning the schedule management service. The page generation script 31 causes the computer to execute the steps of acquiring, from the table, the data needed to provide the schedule management service, and outputting the acquired data. It is assumed that the page generation script 31 is executed together with a data access script 32 and a data access script 33 for browsers, which will be described later. The page generation script 31 includes description for acquiring the needed data from the table by calling functions provided by the other scripts simultaneously executed.

FIG. 8 is a diagram showing an example of the page generation script 31. In the example of FIG. 8, line numbers are indicated on a left side for the purpose of explanation. It is assumed that the page generation script 31 shown in FIG. 8 is a script for acquiring the data concerning the schedule management and displaying a list of the acquired data.

As shown in FIG. 8, a step of calling “DataAccessor.get” (the fourth line) is described in the fourth line of the page generation script 31. The “DataAcessor.get” is a function for accessing the schedules table 4-10 so as to acquire a record (hereinafter, referred to as schedule data). The “DataAccessor.get” function is defined in the data access script 32 and the data access script 33 for browsers, which will be described later. The step in the fourth line is defined so as to arrange the record in order of a value of the date column, and to acquire 20 pieces of the records according to the order, from the schedules table 4-10.

Additionally, the page generation script 31 indicates a step of acquiring the record (hereinafter, referred to as user data) from the “users” table for each schedule data by using a user_id of the schedule data as a key (the seventh line). Thereby, the record of the users table 4-20 related to the acquired record of the schedule information is acquired.

In addition to these, the page generation script 31 includes a step of outputting a “date” field of the schedule data (the ninth line), a step of outputting the user data (the tenth line), a step of outputting a “content” field of the schedule data (the eleventh line), and the like. A “p” function is defined in the data access script 32 and the data access script 33 for browsers, which will be described later.

The data access script 32 (corresponding to a first program of the present invention) is a script for accessing the RDBMS and acquiring the necessary data. The data access script 32 is executed in the application provider 30. The data access script 32 causes the application provider 30 to execute the steps of: reading the data allocated position corresponding to the table name from the data allocated position information storage unit 306; determining whether the publicly-available data is managed in the table indicated by the table name depending on whether the read allocated position is the application provider 30; and accessing the exported data storage unit 305 and reading the publicly-available data from the table indicated by the table name, only when the publicly-available data is managed by the table indicated by the table name, the publicly-available data satisfying the condition. Specifically, the data access script 32 indicates a function for accessing the data of the table that satisfies the condition, by use of the table name and the condition as arguments. Incidentally, a processing of access to these tables is performed by using the function provided by the data API 304. The data access script 32 also indicates a function for outputting the data.

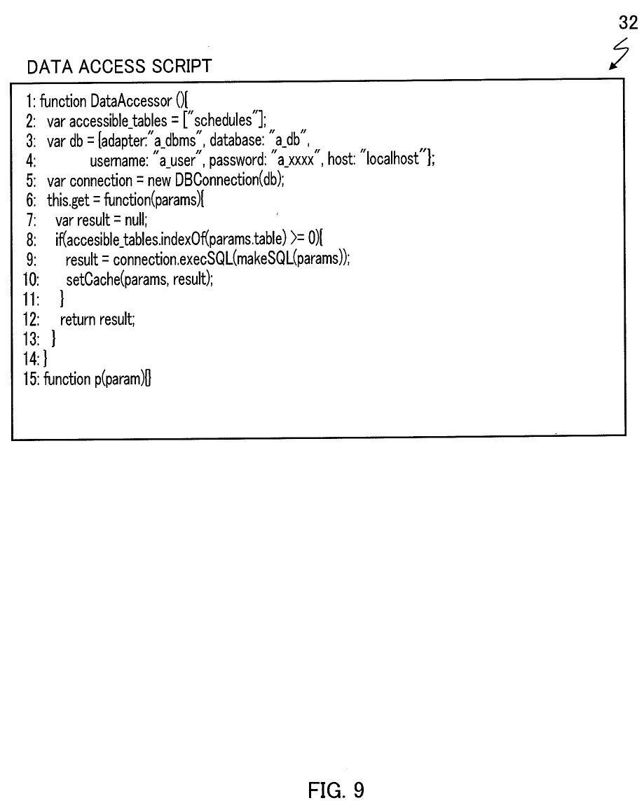

FIG. 9 is a diagram showing an example of the data access script 32. The data access script 32 indicates, in its eighth line, a step of determining whether the table name set as an argument is registered in the publicly-available data storage unit 305. Additionally, the data access script 32 indicates a step of acquiring the publicly-available data stored in the publicly-available data storage unit 305 (the ninth line), and a step of outputting the acquired publicly-available data as a data stream (hereinafter, referred to as a cache) (the tenth line). As described later, the cache generated in the data access script 32 is sent to the user terminal 10 while being attached to the page generation script 31 together with the data access script 33 for browsers.

Like the data access script 32, the data access script 33 (corresponding to a second program of the present invention) for browsers is provided with a description of a function for accessing the data of the table that satisfies the condition, by use of the table name and the condition as arguments. The data access script 33 for browsers is executed in the user terminal 10. The data access script 33 for browsers is a program that causes the user terminal 10 to execute the steps of: reading the data that suits the table name and the condition from the cache attached to the page generation script 31; and accessing the data provider 20 with regard to the data that cannot be read from the cache, and acquiring the data that satisfies the condition from the table indicated by the table name, the data being managed by the secret data storage unit 205.

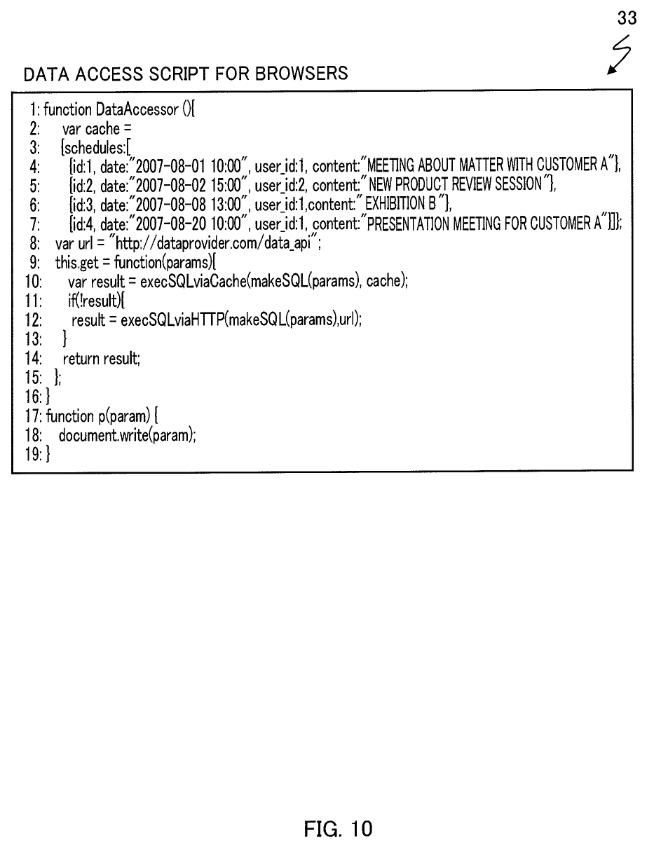

FIG. 10 is a diagram showing an example of the data access script 33 for browsers. It is assumed that in the data access script 33 for browsers, the table name is passed as an argument (params). The tenth line of the data access script 33 for browsers indicates a step of searching the data corresponding to the table name from the cache. The eleventh and twelfth lines describe a step of accessing the data provider 20 when the data cannot be retrieved from the cache, and retrieving the data from the table indicated by the table name.

Details of a processing when executing the above-mentioned script will be described later.

In response to the HTTP request sent from the user terminal 10, the Web server 301 returns the Web page described in the HTML to the user terminal 10, or executes various kinds of programs so as to return the result to the user terminal 10 as the Web page. The script is executed by the web browser 11 of the user terminal 10 when the script is included in the Web page.

The reference processing page processing function 302 executes the page generation script 31 and the data access script 32, when the HTTP request received by the web server 301 includes the reference request for the data needed for the schedule management service. When executing the data access script 32, the reference processing page processing function 302 calls the data API function 304 to access the publicly-available data storage unit 305, and acquires the publicly-available data from the table managed by the publicly-available data storage unit 305. The reference processing page processing function 302 sends the cache generated by execution of the page generation script 31 and the data access script 33 for browsers to the user terminal 10, the cache and the data access script 33 for browsers being attached to the page generation script 31.

The update processing page processing function 303 executes the page generation script 31 in response to the HTTP request received by the Web server 301. When the update request for the publicly-available data is included in the HTTP request, the update processing page processing function 303 calls the data API function 304 to access the publicly-available data storage unit 305, and updates the publicly-available data.

### 4. Procedures

4.1. When there is No Secret Information

First, description will be given when there is no secret data, i.e., when the data provider 20 is unnecessary. In this case, the Web application that provides the schedule management service is a general application that operates only on the application provider 30.

### 4.1.1. Procedure of a Reference Processing

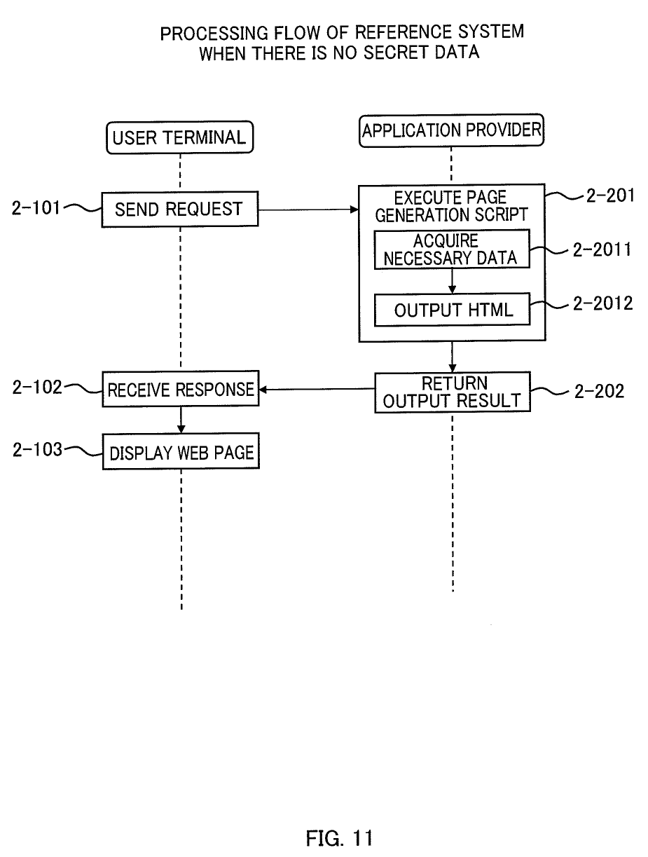

FIG. 11 is a diagram showing a flow of a processing for the reference request when there is no secret data.

First, in response to the user's operation, the user terminal 10 sends, to the application provider 30, a request including a reference request for referring to the schedule (Step 2-101).

When receiving the request from the user terminal 10, the application provider 30 performs a processing according to the reference request (Step 2-201). The application provider 30 performs, for example, a processing to acquire the data needed to generate the page (Step 2-2011) and a processing to output HTML of the reference page by using the acquired data (Step 2-2012), so as to create the Web page to be returned to the user terminal 10. The application provider 30 returns the generated Web page to the user terminal 10 that is a source of the request (Step 2-202).

The user terminal 10 receives the Web page returned by the application provider 30 (Step 2-102), and then displays the received Web page on the screen (Step 2-103).

With the above-mentioned processing, the user browses the Web page generated by use of only the information managed by the application provider 30.

### 4.1.2. Procedure of Update Processing

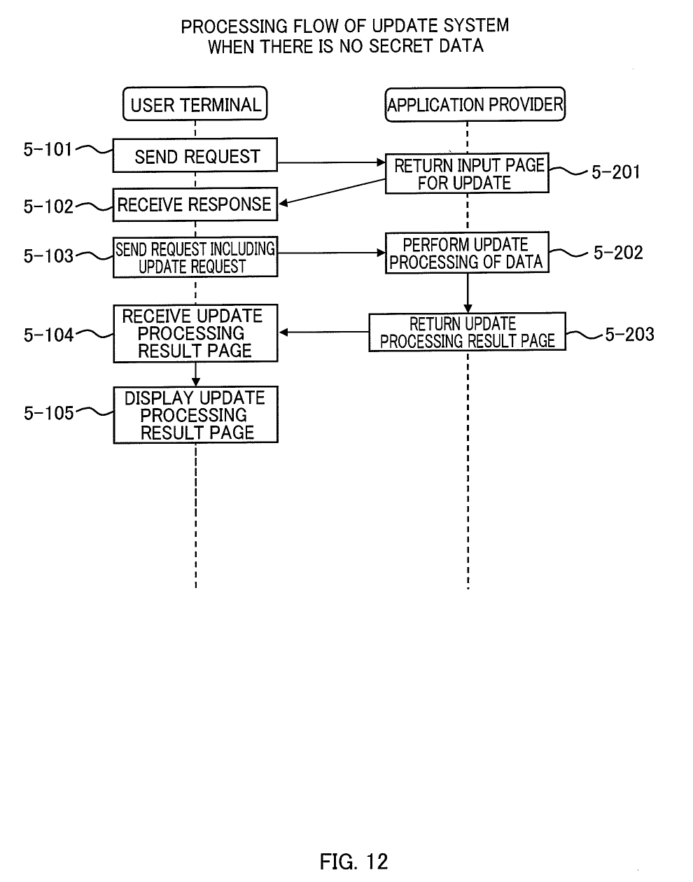

When updating the data, the browser of the user terminal 10 displays the Web page for inputting the data (hereinafter, referred to as an input page for update). The user inputs the necessary information into the input page for update, operates the browser, and sends the information to the application provider 30. Thereby, the Web page that shows the result of the update processing (hereinafter, referred to as an update processing result page) is returned from the application provider 30, and the update processing result page is displayed on the user terminal 10. FIG. 12 is a diagram showing a flow of the update processing of the data when no secret data exists.

First, triggered by the user's operation, the request having the specified input page for update is sent from the user terminal 10 to the application provider 30 (Step 5-101).

When receiving the request, the application provider 30 returns the input page for update specified by the request, to the user terminal 10 of the request source by use of the update processing page processing function 303 (Step 5-201).

The user terminal 10 reads the input page for update received from the application provider 30, and displays the input page for update on the screen (Step 5-102). The user operates the browser and inputs the data, for example, time or content of schedule about a newly added schedule, into the input page for update. The user terminal 10 sends the request including the update request to the application provider 30 in response to an instruction from the user to send the request (Step 5-103). The data inputted by the user is also attached to the request.

When receiving the request including the update request, the application provider 30 performs the update processing through data registration or the like by use of the update processing page processing function 303 (Step 5-202), the data being attached to the request and registered in the publicly-available data storage unit 305. Then, the application provider 30 generates the update processing result page that shows the result of the update processing, and returns the generated update processing result page to the user terminal 10 of the request source (Step 5-203). Alternatively, the page generation script 31 for performing the above-mentioned update processing and generating the update processing result page may be prepared, and then executed by the application provider 30.

When receiving the update processing result page (Step 5-104), the user terminal 10 reads the received update processing result page, and displays the received update processing result page on the screen (Step 5-105).

With the above-mentioned processing, the user can perform processing to update the data managed by the application provider 30, and browse the update processing result page that shows the result.

4.2. When there is Secret Information

Next, a description will be given for a procedure when secret data exists, that is, when the data provider 20 is included in the information processing system.

### 4.2.1. Preparation in the Data Provider

First, preparation in the data provider 20 will be described.

An administrator of the data provider 20 selects the data corresponding to the secret data among the data dealt within the application provider 30. In the present embodiment, the secret data is the data stored in the users table 4-20. If there is the data already used in the application provider 30, the administrator extracts the content of the users table 4-20 corresponding to the secret data from the publicly-available data storage unit 305 in the application provider 30, and migrates the content to the secret data storage unit 205 in the data provider 20. The administrator installs the data provider 20 so that the data provider 20 is coupled to a predetermined network within the organization. The administrator creates the data allocated position information storage unit 306 in the application provider 30, and registers the records. The records include a record in which: the user organization is set as “A_COMPANY” showing the organization to which the data provider 20 belongs; the table name is set as “schedules;” and the allocated position is set as “application provider;” and the records also include a record in which the user organization is set as “A_COMPANY;” the table name is set as “users;” and the allocated position is set as “data provider.”

The administrator installs the data API function 204 for accessing the table “users” managed in the secret data storage unit 205, from the outside. The administrator installs the reference processing page processing function 202 and the update processing page processing function 203 in the data provider 20. The update processing page processing function 203 has a function that executes the same processing as the update processing page processing function 203 held by the application provider 30, the secret data storage unit 205 being subjected to such function. The reference processing page processing function 202 will be described later.

### 4.2.2. Procedure of Reference Processing

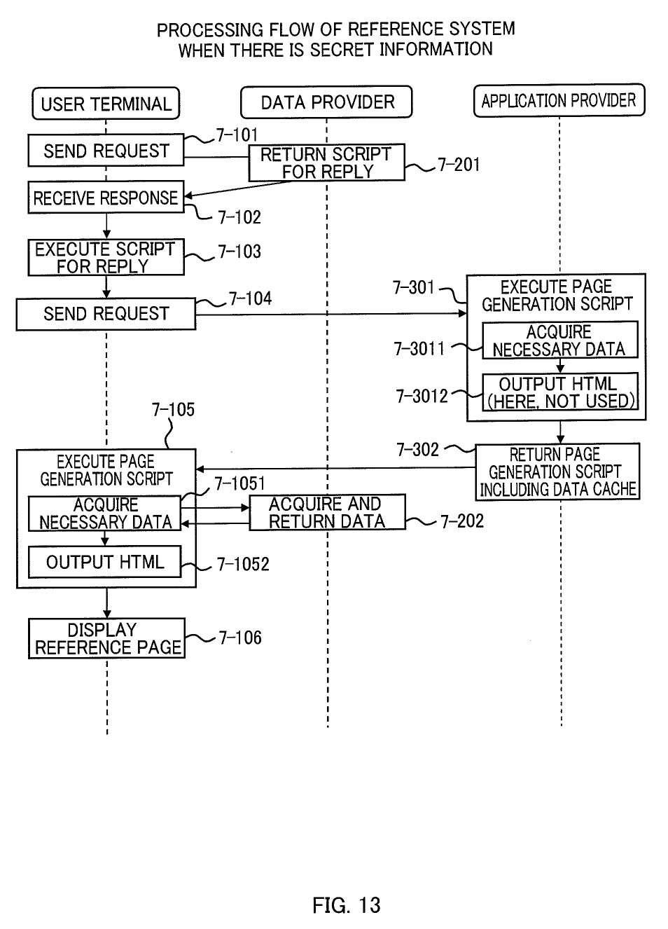

FIG. 13 is a diagram showing a flow of the processing for a reference request when the secret data exists.

Triggered by user's operation, the user terminal 10 sends a request including the reference request to the data provider 20 (Step 7-101).

When receiving the request from the user terminal 10, the data provider 20 returns the script 21 for reply to the user terminal 10 (Step 7-201).

The user terminal 10 receives the script 21 for reply (Step 7-102), displays the received script 21 for reply on the screen, and simultaneously executes a script included in the script 21 for reply (Step 7-103). As mentioned above, since the command (the fourth line) to access the application provider 30 is described in the script 21 for reply, the user terminal 10 sends the request to the application provider 30 in response to the command (Step 7-104).

When receiving the request from the user terminal 10, the application provider 30 executes the page generation script 31 and the data access script 32 (Step 7-301).

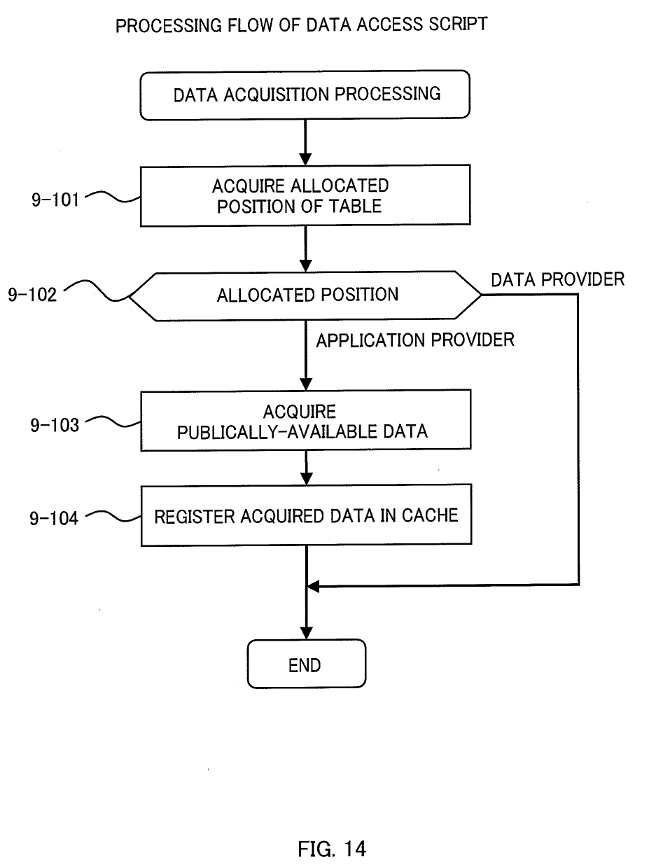

FIG. 14 is a diagram showing a flow of a data acquisition processing defined as the DataAccessor.get function in the data access script 32. Incidentally, the processing shown in FIG. 14 is executed by specifying the table name indicating the table of an access destination and the condition on the record to be acquired, and by calling the above-mentioned function from the processing defined in the page generation script 31.

When the application provider 30 executes the data access script 32, the application provider 30 acquires the allocated position corresponding to the specified table name from the data allocated position information storage unit 306 (Step 9-101). When the acquired allocated position is the “application provider” (Step 9-102: application provider), the publicly-available data that satisfies the specified condition is acquired from the table by the data API function 204 (Step 9-104), the table being indicated by the table name managed in the publicly-available data storage unit 305. The application provider 30 registers the acquired publicly-available data in the cache, in association with the table name (Step 9-105).

For instance, an example of the data allocated position information storage unit 306 shown in FIG. 7 shows that the schedules table 4-10 is managed by the application provider 30, and that the users table 4-20 is managed by the data provider 20. In this case, the record of the schedules table 4-10 is registered in the cache by the above-mentioned processing, but the table of the users table 4-20 is not accessed, the record of the users table 4-20 is not registered in the cache.

As mentioned above, the application provider 30 executes the DataAcessor.get function defined in the data access script 32 and called from the page generation script 31, acquires the data corresponding to the table name, and registers the data in the cache (Step 7-3011). Then, the application provider 30 executes the p function to output the acquired data (Step 7-3012). Since in the data access script 32 of FIG. 9, the p function has a setting so that nothing should be performed, no processing is performed at Step 7-3012.

Next, the application provider 30 returns, to the user terminal 10 of the request source, a script having the cache generated in the above-mentioned processing and the data access script 33 for browsers which are contained in the page generation script 31 (hereinafter, referred to as a page generation script with a cache) (Step 7-302).

When receiving the page generation script with the cache, the user terminal 10 executes the received page generation script (Step 7-105). At the time of execution of the page generation script with the cache, the data access script 33 for browsers included in the page generation script with the cache is also executed.

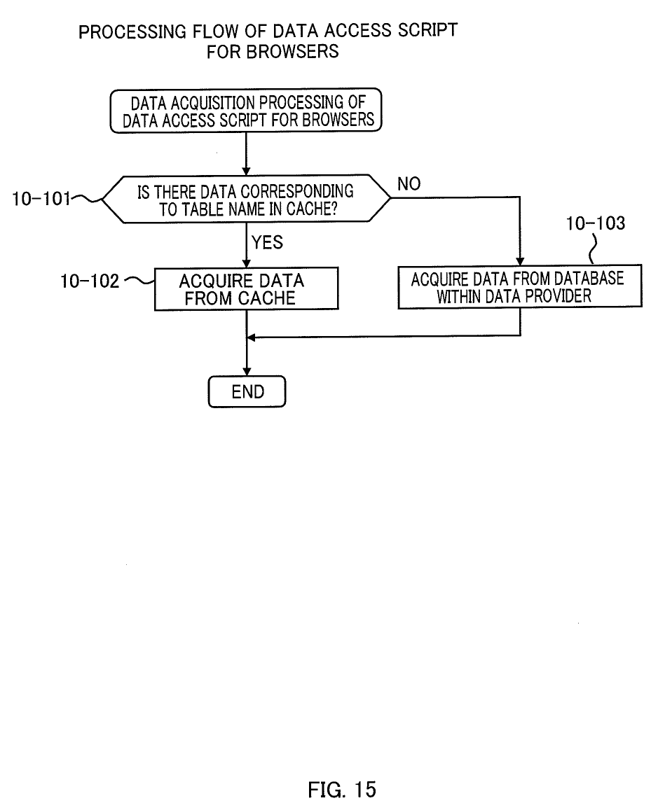

FIG. 15 is a diagram showing a flow of a data acquisition processing defined as the DataAccessor.get function in the data access script 33 for browsers. Incidentally, the processing shown in FIG. 15 is executed by specifying the table name indicating the table of an access destination and the condition on the record to be acquired and by calling the above-mentioned function from the processing defined in the page generation script 31.

When executing the data access script 33 for browsers, the user terminal 10 determines whether the data corresponding to the specified table name is registered in the cache (Step 10-101). If the data is registered in the cache (Step 10-101: yes), the user terminal 10 acquires the data from the cache (Step 10-102). If the data is not registered in the cache, (Step 10-101: no), the user terminal 10 sends the request having the specified table name and condition to the data provider 20, and receives the secret data that the data provider 20 acquires from the secret data storage unit 205 through the data API function 204, and thereby acquires the secret data (Step 10-103). In the present embodiment, the record is acquired from the users table 4-20 in Step 10-103.

As mentioned above, the data registered in the cache, i.e., the publicly-available data retrieved by the application provider 30, and the secret data acquired by accessing the data provider 20 by the user terminal 10 are acquired.

As mentioned above, by executing the DataAcessor.get function called from the page generation script 31 and defined in the data access script 33 for browsers, the user terminal 10 acquires, from the cache, the publicly-available data corresponding to the table name, and simultaneously, acquires, from the data provider 20, the secret data corresponding to the table name (Step 7-1051). The user terminal 10 executes the p function for outputting the acquired data, and outputs HTML for displaying the acquired data on the screen (Step 7-1052).

By execution of the page generation script 31, the publicly-available data and the secret data are outputted on the web browser 11 as mentioned above (Step 7-106).

As described above, according to the information processing system of the present embodiment, among the data needed for the service provided by the application provider 30, the secret data is managed by the data provider 20 installed within the organization, whereas only the publicly-available data is managed by the application provider 30. As a result, both the publicly-available data stored in the application provider 30 and the secret data stored in the data provider 20 can be displayed on the user terminal 10. Since the secret data is not managed in the application provider 30, even when the application provider 30 is operated by the service providers other than the user's organization, the risk of leakage of the secret data can be reduced.

Moreover, since the data provider 20 is not accessed from the application provider 30, the data provider 20 can also be installed in a site where the data provider 20 cannot communicate with the application provider 30. This allows no access from the application provider 30 to the secret data managed in the data provider 20. Accordingly, when the organization that operates the application provider 30 is different from the organization that operates the user terminal 10 and the data provider 20, the data managed in the application provider 30 may be browsed by a user of the organization operating the application provider 30, yet a possibility that the data managed in the data provider 20 may be browsed by the above-mentioned user is eliminated. As a consequence, data security can be kept.

Additionally, since the publicly-available data containing no secret data can be managed by the application provider 30, load on the data provider 20 can be minimized.

Furthermore, in the present embodiment, while the application provider 30 and the user terminal 10 execute the same page generation script 31, the application provider 30 and the user terminal 10 execute the scripts for data access that are different from each other (data access script 32 and data access script 33 for browsers). This allows access to the publicly-available data storage unit 305 at the time of execution of the script in the application provider 30, and allows access to the secret data storage unit 205 at the time of execution of the script in the user terminal 10. Therefore, the secret data and the publicly-available data can be managed by different computers, without changing logic of the page generation script 31 in which operation of the application is specified.

Moreover, even when the logic defined in the page generation script 31 is changed, a necessary procedure is to update only the page generation script 31, and thus updating operation of the script in the application provider 30 can be facilitated.

Moreover, since it is unnecessary to consider where the secret data is stored at the time of development of the page generation script 31, efficiency of developing the page generation script 31 can be improved.

In addition, when data security is unnecessary, the application can also be used by using the user terminal 10 to access only the application provider 30, while not installing the data provider 20. In this case, only the data allocated position information storage unit 306 is updated in the application provider 30, and the configuration of any other units of the application provider 30 does not need to be changed. Accordingly, the configuration of the information processing system can be flexibly varied. Furthermore, since the user can freely set the secret data in the data allocated position information storage unit 30, the system can be flexibly designed.

### 4.2.3. Procedure of Update Processing

In an update processing in the information processing system when the secret data exists, the update request is sent to the data provider 20 when updating the secret data, whereas the update request is sent to the application provider 30 when updating the publicly-available data. Since the update processing page processing function 203 is installed also in the data provider 20, the secret data managed in the secret data storage unit 205 is updated through the same update processing illustrated in FIG. 12.

While the organization to which the user belongs is a business enterprise in the present embodiment for the purpose of simple description, but is not limited to this, and the user may not belong to an organization and the user as an individual may deal with the data that the user desires to keep secret.

Additionally, the user terminal 10 may include each function included in the data provider 20. In this case, the functions of the data provider 20 may be installed as an application program independent of the web browser 11, or may be installed as a plug-in program of the web browser 11.

### 5. Keep the Data Secret in Record Units

Hereinafter, a description will be given for a modification example in which record units are used as a management unit for the secret data, and the data is kept secret in record units.

While table units of the database are used as the management unit for the secret data in the above-mentioned embodiment, record units may be used instead of this. In this case, by causing the data provider 20 and the application provider 30 to manage the table having the same table name, it is determined that the record stored in the table managed in the data provider 20 is the secret data and the record stored in the table managed in the application provider 30 is the publicly-available data.

In the schedule management service, it is determined whether units of the record storing the schedule information are the secret data or the publicly-available data. Thereby, for example, even when the schedule information to be publicly-available to outside and the schedule information desired not to be publicly-available to outside coexist, the schedule information to be publicly-available to outside may be managed by the application provider 30 while the schedule information desired not to be publicly-available to outside may be managed by the data provider 20. As a result, the amount of information to be managed by the data provider 20 can be reduced.

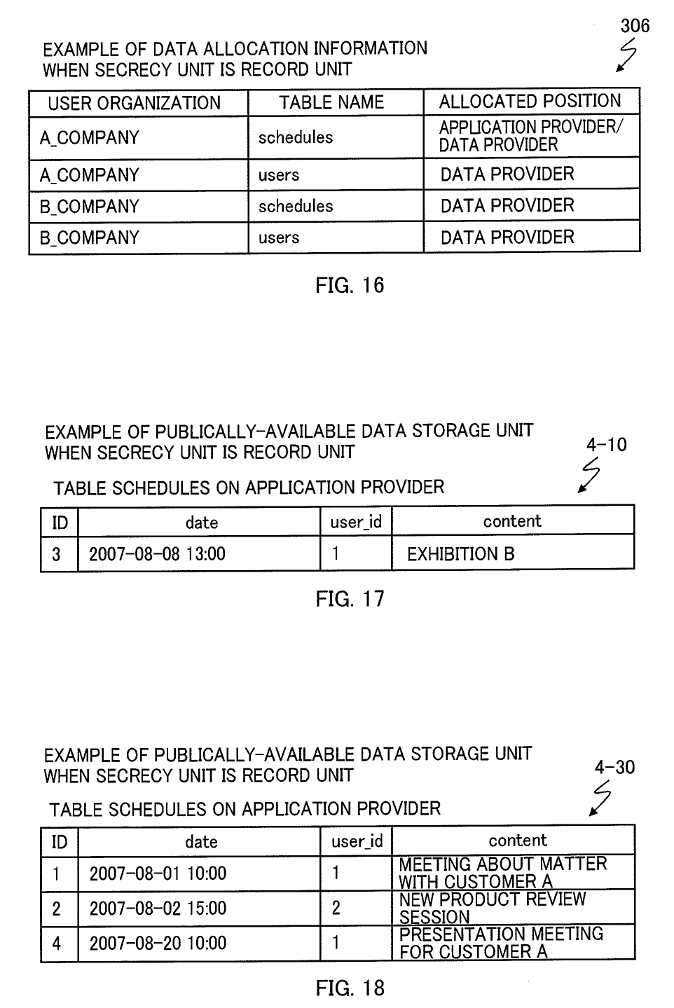

FIG. 16 shows an example of the data allocated position information stored in the data allocated position information storage unit 306, in the present modification example. As shown in the drawing, both the application provider 30 and the data provider 20 are set for allocated information corresponding to “A_COMPANY” and “schedules.” This shows that the schedules table 4-20 is managed by both the application provider 30 and the data provider 20.

In the present modification example, it is assumed that the record whose id of the schedules table shown in FIG. 6 is “3” is managed by the data provider 20 as the secret data.

FIG. 17 shows an example of a configuration of the schedules table managed by the publicly-available data storage unit 305 of the application provider 30. In the example of FIG. 17, only the record whose id is “3” among the records registered in the table 4-10 shown in FIG. 6 is registered.

FIG. 18 shows an example of the schedules table 4-30 managed by the secret data storage unit 205 of the data provider 20. As shown in the drawing, the schedules table 4-30 managed in the data provider 20 has the same configuration as the schedules table 4-10 managed in the application provider 30. The records except the record whose id is “3” among the records registered in the table 4-10 shown in FIG. 6 are registered in the schedules table 4-30 managed in the data provider 20.

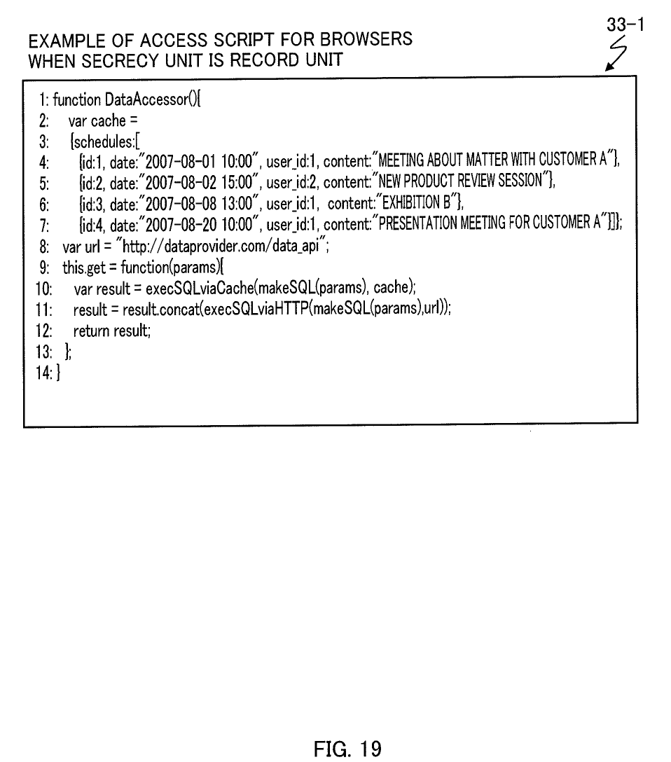

In the modification example, an access script 33-1 for browsers shown in FIG. 19 is used instead of the access script 33 for browsers. In the access script 33-1 for browsers shown in FIG. 19, the definition of the judging processing performed so as to access the data provider 20 only when the data is not registered in the cache is omitted (the eleventh line of FIG. 19), the definition of the judging processing being performed according to the eleventh line of the data access script 33 for browsers shown in FIG. 10. Therefore, in the modification example, when the user terminal 10 executes the data access script 33-1 for browsers, even though the publicly-available data corresponding to the table name in the cache returned from the application provider 30 is stored, the table of the table name managed by the data provider 20 is accessed to acquire the secret data. In other words, in the modification example, the table having the same table name is managed in the data provider 20 and the application provider 30. The data is retrieved for both of the tables, and the publicly-available data acquired from the table managed by the application provider 30 are linked to the secret data acquired from the table managed by the data provider 20 (the eleventh line). This allows the data to be managed in record units, based on the premise that the data managed in the data provider 20 is the secret data, and the data managed in the application provider 30 is the publicly-available data.

### 5.1. Procedure for Data Security in Record Units

### 5.1.1. Procedure of Update Processing

Even when the data is kept secret in record units, the update processing is also the same as in the case of the embodiment mentioned above. For the publicly-available data, the user terminal 10 accesses the application provider 30, and updates the information on the publicly-available data storage unit 305 held by the application provider 30, by using the update processing page processing function 303. For the secret data, the user terminal 10 is coupled to the data provider 20, and updates the information on the secret data storage unit 205 held by the data provider 20, by using the update processing page processing function 203.

### 5.1.2. Procedure of Reference Processing

When the data is kept secret in record units, a flow of the processing for the reference request is also the same as the processing flow shown in FIG. 13, except that the page generation script with the cache sent by the application provider 30 in Step 7-302 includes the cache and the access script 33-1 for browsers in the page generation script 31, and the script executed by the user terminal 10 in Step 7-105 is the page generation script 31 and the access script 33-1 for browsers.

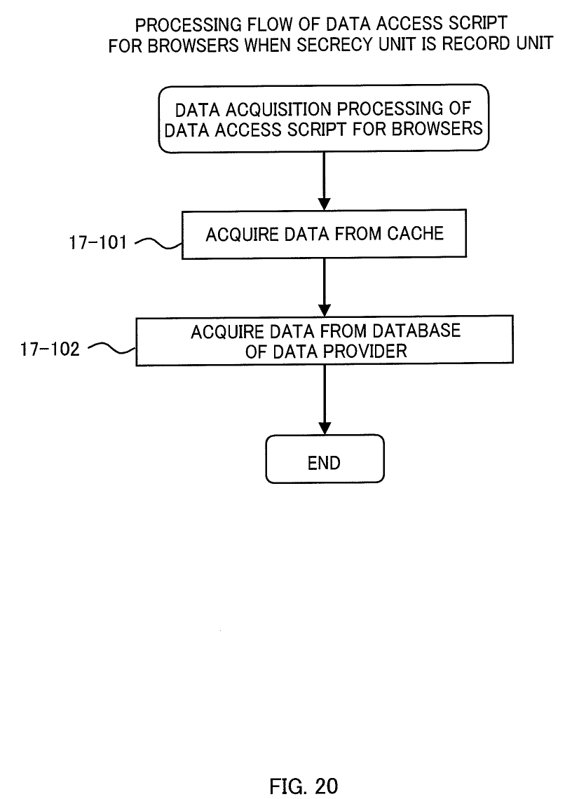

FIG. 20 is a diagram showing a flow of the data acquisition processing defined as the DataAccessor.get function in the data access script 33-1 for browsers. The processing shown in FIG. 20 is executed by specifying the table name indicating the table of the access destination and the condition on the record to be acquired, and by calling the above-mentioned function from the processing defined in the page generation script 31.

When executing the data access script 33-1 for browsers, the user terminal 10 acquires the data corresponding to the specified table name, from the cache (Step 17-101). Simultaneously, the user terminal 10 sends the request having the specified table name and condition to the data provider 20, and receives the secret data acquired from the secret data storage unit 205 through the data API function 204, thereby acquiring the secret data (Step 10-103).

The above-mentioned processing also enables the data security in record units.

For example, the secret data is managed by the data provider 20 for every record in the above-mentioned embodiment. Nonetheless, the data provider 20 may manage a part of the records by use of a tally system, for instance.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and medications within the ambit of the appended claims.

What is claimed is:

1. An information processing apparatus communicably coupled with a user terminal communicably coupled with a secret data management device managing secret data that a user intends to keep secret, the information processing apparatus comprising:
a publicly-available data storage unit that stores publicly-available data that the user does not intend to keep secret;
a publicly-available data acquiring unit that reads the publicly-available data from the publicly-available data storage unit;
a program storage unit that stores a program to be executed by the user terminal; and
a program sending unit that sends the program to the user terminal with the read publicly-available data attached to the program, wherein
the program contains instructions to cause the user terminal to execute the steps of:
acquiring the secret data by accessing the secret data management device; and
outputting the acquired secret data and the publicly-available data attached to the program.

2. The information processing apparatus according to claim 1, comprising:
a condition storage unit that stores a condition for reading data, wherein
the publicly-available data acquiring unit reads the publicly-available data that matches the condition,
the program sending unit sends the program to the user terminal with the publicly-available data and the condition attached to the program, and
the program contains instructions to cause the user terminal to acquire the secret data that matches the condition attached to the program, in the step of acquiring the secret data.

3. The information processing apparatus according to claim 1, further comprising a secret table storage unit, a publicly-available table storage unit, and an access information storage unit, wherein
the secret data management device includes a database that manages the secret data in a table, and
the publicly-available data storage unit is a database that manages the publicly-available data in a table,
the secret table storage unit stores a table name of the table managed by the secret data management device,
the publicly-available table storage unit stores a table name of the table managed by the publicly-available data storage unit,
the access information storage unit stores access information that is information including a plurality of table names of tables accessed,
the publicly-available data acquiring unit acquires the publicly-available data from the table indicated by a table name that is included in the table names of the access information and is stored in the publicly-available table storage unit,
the program sending unit sends the program to the user terminal, with attachment of each table name that is included in the table names of the access information and also is stored in the secret table storage unit, and with attachment of the publicly-available data of the each table name, and
the program contains instructions to cause the user terminal in the step of acquiring the secret data to acquire the secret data by accessing the table that is indicated by the table name attached to the program and is managed by the secret data management device.

4. The information processing apparatus according to claim 3, wherein
the access information is a program executed together with a different program,
the different program executed together with the access information is a program for acquiring output data from a table indicated by the table name specified as an argument,
the access information is a program containing instructions for causing the information processing apparatus or the user terminal to execute a step of calling the different program by using each of the table names as an argument,
the access information storage unit stores the access information, a first program, and a second program,
the first program contains instructions to cause the information processing unit to execute the steps of:
determining whether the table name given as an argument is stored in the publicly-available table storage unit; and
acquiring the publicly-available data, as the output data, from the table that is managed by the publicly-available data storage unit and is indicated by the table name, when the table name is stored in the publicly-available table storage unit,
the second program contains instructions to cause the user terminal to execute the steps of:
determining whether the publicly-available data corresponding to the table name given as the argument is attached;
acquiring, as the output data, the publicly-available data corresponding to the table name, when the publicly-available data corresponding to the table name is attached; and
acquiring, as the output data, the secret data from the table indicated by the table name, by accessing the secret data management device, when the publicly-available data corresponding to the table name is not attached,
the publicly-available data acquiring unit is implemented by executing the access information and the first program by the information processing apparatus, and
the program sending unit sends the second program and the access information to the user terminal.

5. An information processing system comprising a first and a second information processing apparatuses, wherein
the first and second information processing apparatuses are coupled communicably with each other,
the first information processing apparatus is communicably coupled with a user terminal,
the first information processing apparatus includes a secret data storage unit that stores secret data that a user intends to keep secret,
the second information processing unit is communicably coupled with the user terminal,
the second information processing apparatus includes:
a publicly-available data storage unit that stores publicly-available data that the user does not intend to keep secret;
a publicly-available data acquiring unit that reads the publicly-available data from the publicly-available data storage unit;
a program storage unit that stores a program to be executed by the user terminal; and
a program sending unit that sends the program to the user terminal with the read publicly-available data attached to the program, and
the program contains instructions to cause the user terminal to execute the steps of:
acquiring the secret data by accessing the secret data management device; and
outputting the acquired secret data and the publicly-available data attached to the program.

6. An information processing system comprising a first and a second information processing apparatuses according to claim 5, comprising:
a secret table storage unit;
a publicly-available table storage unit; and
an access information storage unit, wherein
the secret data storage unit is a database that manages the secret data in a table, and
the publicly-available data storage unit is a database that manages the publicly-available data in a table,
the secret table storage unit stores a table name of the table managed by the secret data storage unit,
the publicly-available table storage unit stores a table name of the table managed by the publicly-available data storage unit,
the access information storage unit stores access information including a plurality of table names of tables to be accessed,
the publicly-available data acquiring unit acquires the publicly-available data from the table indicated by a table name, that is included in the table names of the access information and is stored in the publicly-available table storage unit;
the program sending unit sends the program to the user terminal, with attachment of each table name that is included in the table names of the access information and also is stored in the secret table storage unit, and with attachment of the publicly-available data of the each table name, and
the program contains instructions to cause the user terminal in the step of acquiring the secret data to acquire the secret data by accessing the table that is indicated by the table name attached to the program and is managed by the secret data management device.

7. A method for controlling information processing with an information processing apparatus communicably coupled with a user terminal communicably coupled with a secret data management device managing secret data that a user intends to keep secret, the method comprising:
a step performed by the information processing apparatus of storing, in a memory, publicly-available data that the user does not intend to keep secret;
a step performed by the information processing apparatus of storing, in the memory, a program to be executed by the user terminal;
a step performed by the information processing apparatus of reading the publicly-available data from the memory; and
a step performed by the information processing apparatus of sending the program to the user terminal with the read publicly-available data attached to the program, wherein
the program contains instructions to cause the user terminal to execute the steps of:
acquiring the secret data by accessing the secret data management device; and
outputting the acquired secret data and the publicly-available data attached to the program.

8. A program for an information processing apparatus communicably coupled with a user terminal communicably coupled with a secret data management device managing secret data that a user intends to keep secret, the program containing instructions for causing the information processing apparatus to execute the steps of:
storing, in a memory, publicly-available data that the user does not intend to keep secret;
storing, in the memory, a user program to be executed by the user terminal;
reading the publicly-available data from the memory;
sending the user program to the user terminal with the read publicly-available data attached to the program, wherein
the user program causes the user terminal to execute the steps of:
acquiring the secret data by accessing the secret data management device; and
outputting the acquired secret data and the publicly-available data attached to the program.
